(19) United States
(12) Patent Application Publication
(10) Pub. No.: US 2014/0143029 A1
(43) Pub. Date: May 22, 2014

(54) System and method for providing nutritional information and incentives via a mobile device

(71) Applicants: Kevin J. Kail, Orlando, FL (US); Mark Widman, Seven Lakes, NC (US)

(72) Inventors: Kevin J. Kail, Orlando, FL (US); Mark Widman, Seven Lakes, NC (US)

(73) Assignee: epcSolutions, Inc.

(21) Appl. No.: 13/694,291

(22) Filed: Nov. 16, 2012

(51) Int. Cl. G06Q 30/06

(52) U.S. Cl. CPC G06Q 30/0623
USPC 705/14.1

(57) ABSTRACT

The invention is directed toward systems and methods facilitating access to manufacturer verified nutritional information of food items and incentives, for example, coupons, discount codes, and the like, using a mobile device, for example, a smartphone, and the like. Scans of food item barcodes or RFID tags facilitate retrieval of information associated with said barcodes or RFID tags via the GS1 system of standards for managing goods.

### RELATED APPLICATIONS

This application claims priority and benefit from U.S. Provisional Patent Application No. 61/629,400, filed Oct. 18, 2011.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### BACKGROUND OF THE INVENTION

1. Field of Invention

The present invention is generally directed toward systems and methods for providing food item nutritional information via a mobile device, for example so-called “smart” mobile telephones and similar handheld devices.

2. Background of the Invention

The advent of the Internet-age and its unprecedented access to information is transforming society in heretofore unimagined ways. E-mail is quickly making the U.S. Postal Service and its so-called “snail mail” a relic of previous generations. Similarly, Facebook®, Twitter®, LinkedIn®, MySpace® and other social networking services are changing the way people communicate, combining the real-time aspects of traditional telephony through their chat and SMS features with so-called “push” functionality in the form of their status update features, yet offering legacy e-mail-like functionalities for those needing this feature. Retailers have been quick to recognize that these social networks present an opportunity to directly solicit customers. Customers, in turn, are leveraging their nearly instant and ubiquitous access to information to comparison shop, post their opinions about particular items, retailers, or manufacturers, or otherwise inform themselves and others with regard to goods or services. Customers are now better-able to identify the best product for their needs and in addition are quickly able to determine where the product can be had at the best price. With particular regard to comparison shopping, the ever increasing popularity of so-called “smart” mobile telephones and similar handheld devices in conjunction with services like SCAVE® from epcSolutions, Inc. or RedLaser® now permit customers to comparison shop online and at local retailers simply by photographing/scanning an item barcode using the camera integrated into their mobile device. More recently, manufacturers and retailers have begun to leverage the power of these technologies to better market their products. For example, Twitter® followers of a particular retailer may be rewarded with a discount or coupon.

With regard to food items, services provided by this invention facilitate consumer access to manufacturer vetted nutritional information regarding grocery items, foodstuffs, and the like via their mobile device. What is needed, however, are means by which manufacturers and retailers may communicate with these consumers, for example, incenting purchases with a coupon, discount, or the like. In a preferred embodiment, the systems and methods of the present invention may incorporate the consumer's personal information, for example, his or her sex, age, weight, specific medical and/or nutritional requirements, and the like in order to present a custom data set specific for that user.

### SUMMARY OF THE INVENTION

The present invention leverages the availability of Internet-enabled (or other communications network-enabled) mobile telephones and similar handheld or portable devices having built-in cameras to facilitate synergistic interaction between users, their peers, manufacturers, and other parties participating in the retail chain of goods using, for example, the GS1 system of standards which is designed to improve supply-chain management. The GS1 System includes four key standards: Barcodes (used to automatically identify things), eCom (electronic business messaging standards allowing automatic electronic transmission of data), GDSN (Global Data Synchronization standards which allow business partners to have consistent item data in their systems at the same time) and EPCglobal (which uses RFID technology to immediately track an item). The systems and methods described in detail below contemplate leveraging the Global Data Synchronization Network (GDSN) data associated with barcode information captured using the aforementioned cameras. It is additionally contemplated that devices capable of scanning an RFID tag may be used in lieu of a barcode scan.

Numerous websites currently exist whereby consumers may access nutritional information pertaining to various food items. They range from sites operated by manufacturers to those operated by independent parties that aggregate this data formally, from the aforementioned manufacturers, or informally, via third parties or crowdsourcing. Typically, an interested consumer will enter search terms into the site, for example, “almonds” or “peanut butter” and be presented thereafter with a list of the possible hits, for example, Emerald® or Blue Diamond® almonds, or JIF® or Skippy® peanut butter. After selecting the desired item, he/she is thereafter presented with nutritional information which may or may not be accurate. While these sites may be usable when the consumer is “surfing” the Web on his or her home or office computer, accessing these sites, typing in search terms, then inspecting the results in order to find (or in many cases, not find) the item being searched for is impracticable to perform, for example, while grocery shopping, or while standing in line at a take-out counter trying to decide between the bottled “lite” green chai tea or a Coke®. Similarly, while Internet “e-coupons” are currently available for those willing to take the time to search for them at their computer desktop, mobile users have no practical means to access these discounts. Additionally, no systems currently exist whereby the accuracy of this information has been checked and authenticated by the actual manufacturer of the goods. In a preferred embodiment, the consumer may integrate his/her specific nutritional requirements into the system, for example, low sodium requirements, a desire to limit carbohydrate intake, allergies, other wellness factors, and the like, whereby the systems and methods of the present invention may, for example, track the glycemic indices of the food items being scanned, maintain a running tally of caloric intake, flag food items which include particular allergens, flag Kosher, Halal, vegetarian, gluten free, genetically modified organism (GMO) free, trans-fat free, or organic items, provide customized nutritional information, and the like, presenting manufacturer verified data.

The present invention leverages the functionality of the global GS1 standards initiative in which registered manufacturers are able to enter and associate nutritional information with, for example, a barcode, RFID tag, or the like. Thereafter, consumers may simply photograph/scan the barcode or RFID tag of the food item using the systems and methods of the present invention to queue up its nutritional information, manufacturer or retailer coupons, discounts, incentives, and the like.

These and other objects, advantages, and novel features of the present invention will become apparent when considered with the teachings contained in the detailed disclosure along with the accompanying drawings.

It is an object of this invention to facilitate consumer access to nutritional data, manufacturer or retailer coupons, discounts, incentives, and the like using their “smart” mobile device;

It is another object of this invention to integrate nutritional data into a customized nutrition plan accessible via a “smart” mobile device; and,

It is yet another object of this invention to provide authenticated nutritional data via a standards-based supply-chain management system, for example the GS1 standards initiative.

### BRIEF DESCRIPTION OF THE DRAWINGS

FIG. 1 is a screenshot of an exemplary graphical user interface of the present invention;

FIG. 2 is another screenshot of an exemplary graphical user interface of the present invention;

FIG. 3 is another screenshot of an exemplary graphical user interface of the present invention;

FIG. 4 is another screenshot of an exemplary graphical user interface of the present invention;

FIG. 5 is another screenshot of an exemplary graphical user interface of the present invention;

FIG. 6 is another screenshot of an exemplary graphical user interface of the present invention;

FIG. 7 is another screenshot of an exemplary graphical user interface of the present invention; and,

FIG. 8 is a flow diagram showing the system and method of the present invention.

### DESCRIPTION OF THE INVENTION

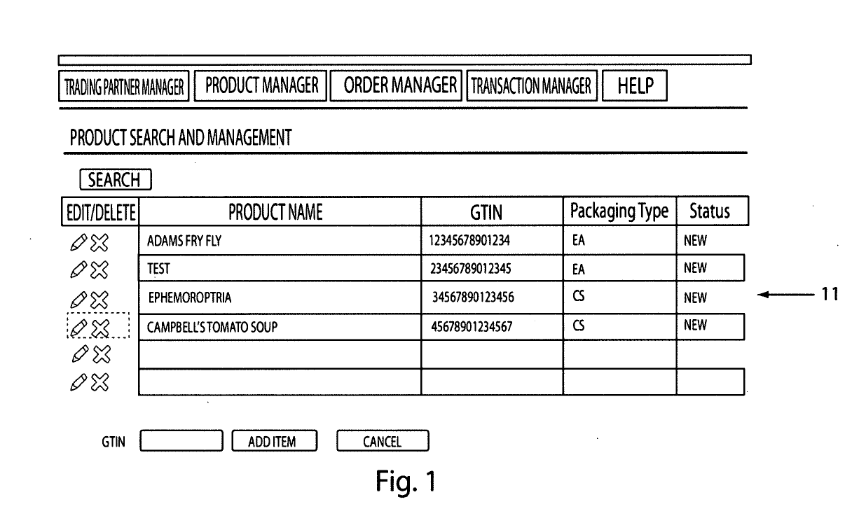

The preferred embodiment and best mode of the invention are shown in FIGS. 1 through 8. While the invention herein is described with regard to certain preferred embodiments, it is not intended that the present invention be so limited. On the contrary, it is intended to cover all alternatives, modifications, and equivalent arrangements as may be included within the spirit and scope of the invention as defined by the subsequent claims.

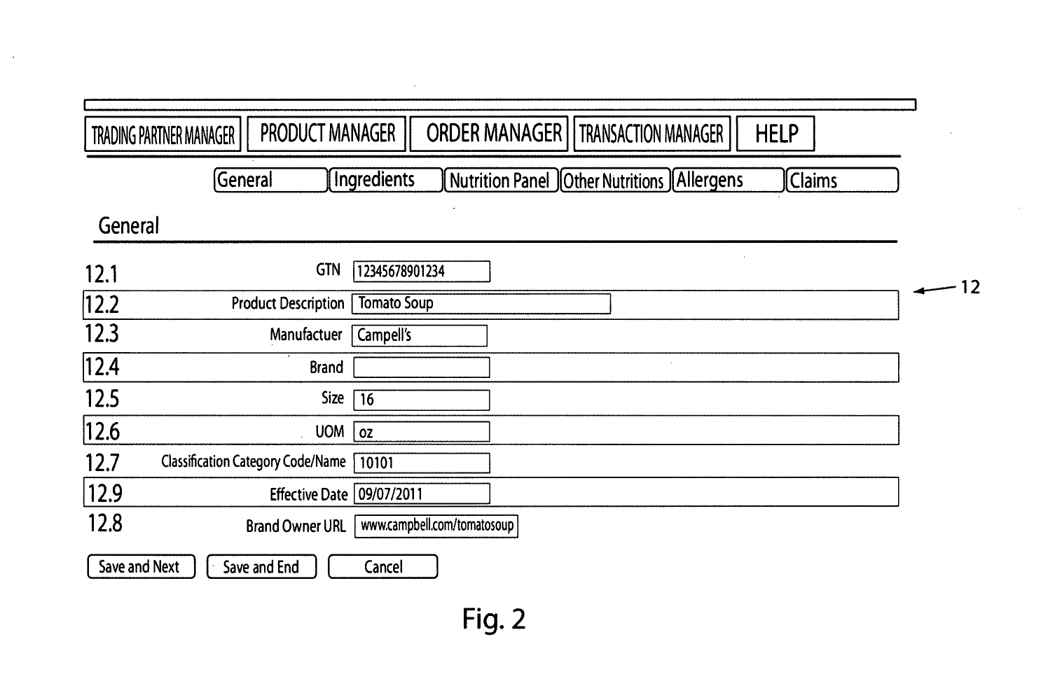

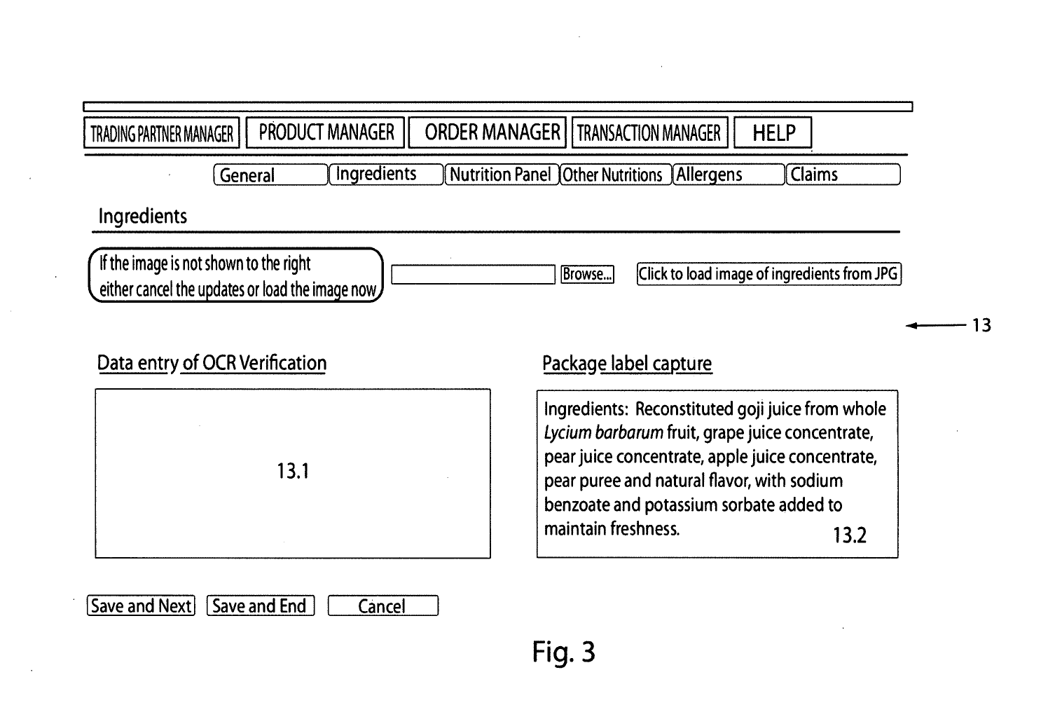

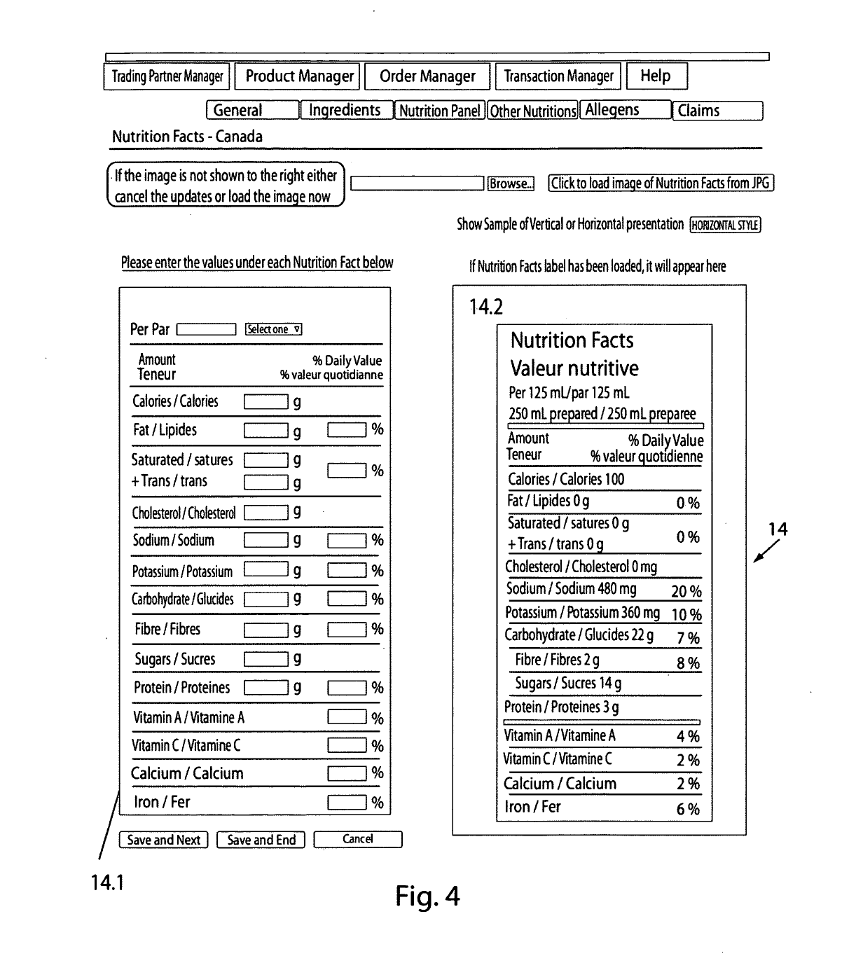

In accordance with the invention, FIGS. 1 through 7 show a graphical user interface, for example the “GS1-In-A-Box®” interface from epcSolutions, Inc.®, the assignee of the present application, whereby manufacturers, retailers, or other responsible parties, fiduciaries, etc. registered with the global GS1 standards initiative may input nutritional and marketing data that will be associated with the barcode, RFID tag, or the like identifying their product throughout the stream of commerce. The data includes but is not limited to, for example, the product name 11 (FIG. 1) and general information 12 (FIG. 2), including, for example, its GTIN 12.1, Product Description 12.2, Manufacturer 12.3, Brand 12.4, Size 12.6, UDM 12.7, the brand owner's website 12.8, and effective date of the information 12.9. In FIG. 3, a GUI 13 is shown wherein product ingredients may be input, either via data entry or OCR 13.1 and depicted 13.2. FIG. 4 shows an interface 14 whereby information required in government mandated nutrition labeling 14.1 may be input. Optionally, an image of this information as it appears on actual product labeling may be uploaded and displayed 14.2.

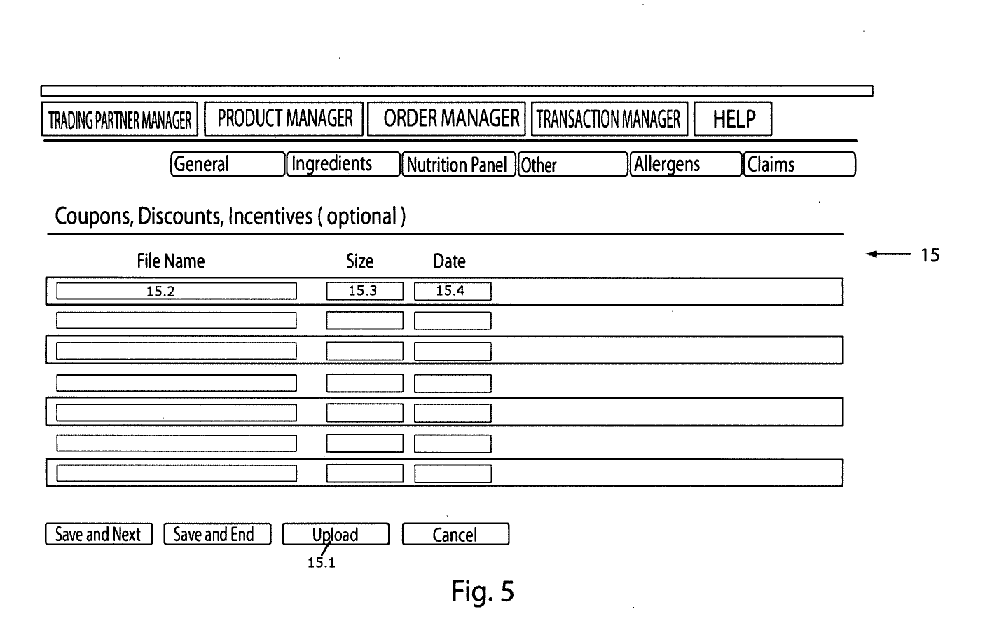

FIG. 5 shows an interface 15 whereby manufacturers, retailers, and the like may include promotional information, for example, coupons, discounts, or other incentives. It is contemplated that the coupons, discounts, incentives, etc. may include, but are not limited to human readable discount codes that may be input at a point of sale; machine readable formats, for example bar codes, quick response codes, and the like; or any other means of delivering an incentive, coupon, or the like as may be known to one skilled in the art. Additionally, it is contemplated that the incentives need not be with regard to the specific product being scanned but may include cross-marketing opportunities. For example, in the case of a manufacturer whose inventory includes both peanut butter and jelly, scanning a jar of peanut butter may yield coupons for the scanned product, but may also yield an incentive for the purchase of its jelly product, or both. Similarly, scanning product A may result in receiving an incentive for the manufacturer's new product B. In rare cases, scanning a product may result in receiving an incentive to purchase a competing product, for example, where a manufacturer has determined it is discontinuing a particular item, or through various mergers, acquisitions, etc. has acquired a competing product. As shown in FIG. 5, in a preferred embodiment the interface 15 functionality includes an “Upload” button 15.1 facilitating the incorporation of files containing incentive information. Once uploaded, said files are listed according to their “File Name” 15.2, “Size” 15.3, and upload “Date” 15.4.

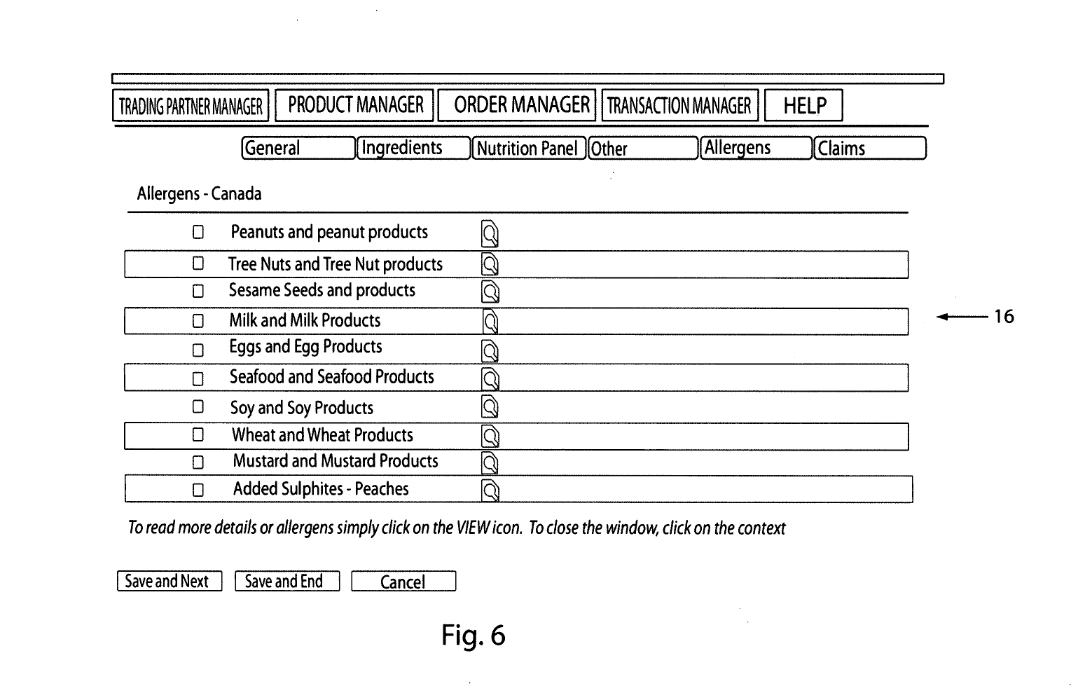

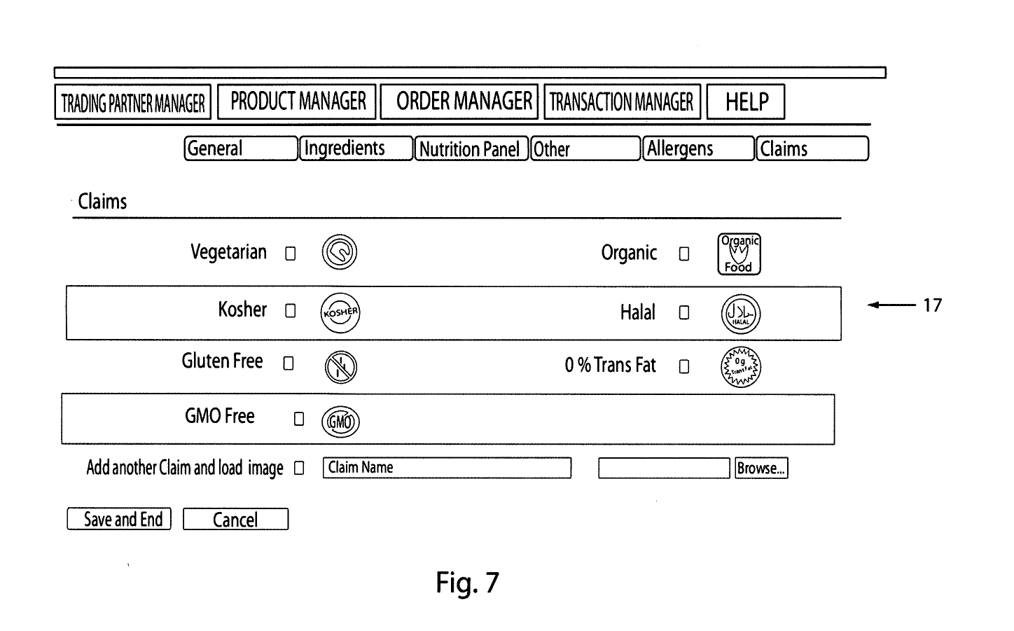

Finally, the present invention FIG. 6 includes an interface 16 whereby potential allergic interactions may be noted and FIG. 7 shows an interface 17 whereby government defined claims, for example, whether the product is vegetarian, gluten-free, organic, or the like, may be noted.

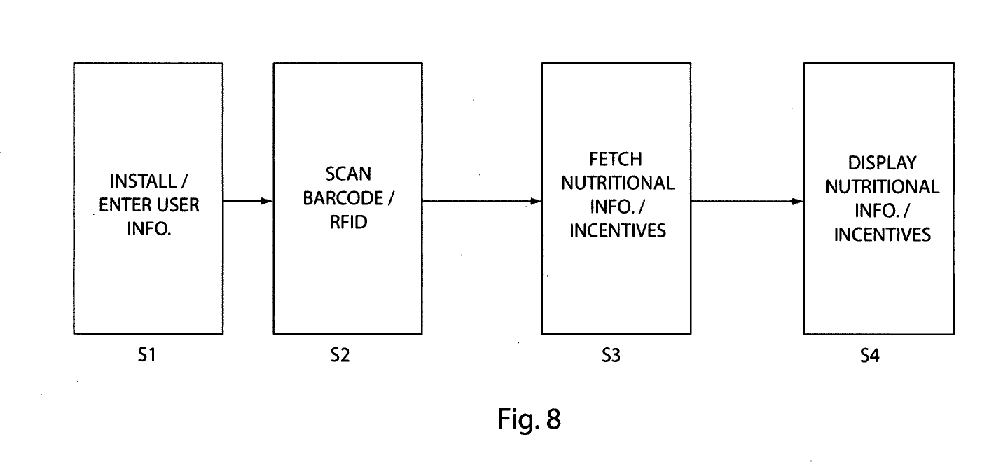

Turning now to FIG. 8 a stepwise flow diagram of the present invention is depicted wherein in a first step S1, the consumer accesses a network site, downloads and installs a software application, executes a binary code or other machine readable instruction on his mobile device, for example his/her “smart” mobile device comprising the consumer interface of the present invention. In a preferred embodiment, the consumer additionally inputs specific information, for example, his/her sex, age, weight, fitness goals, dietary restrictions, and other wellness information such that subsequently displayed information may be customized. Thereafter, in step S2, the consumer simply scans the barcode, RFID tag, or the like affixed to a food item, and in step S3 the systems and methods of the present invention communicate in a conventional manner as known to those skilled in the art with the GS1 system of standards to thereby fetch the previously input nutritional information and incentives, for example, coupons, discount codes, and the like (see FIGS. 1-7). In step S4, nutritional and incentive information are displayed to the consumer. The nutritional information may include a summary of the nutritional information resembling that available on the now-familiar and ubiquitous nutrition labels affixed to all food items sold in the United States, but which has been vetted by the manufacturer. Incentives, for example, coupons, discount codes, and the like are also displayed for the consumer's use at this time. Optionally, the displayed information S4 may provide a degree of granularity as desired by the consumer, for example providing detailed nutritional information, and in cases wherein the consumer has previously input his/her specific information, may include warnings about potential allergens, running tallies of caloric intake, carbohydrate intake, protein intake, fat intake, sodium intake, and the like.

In use, a consumer now has available at his/her fingertips a convenient method for accessing the nutritional data of any comestible for which there is a corresponding GDSN entry. Additionally, manufacturers and retailers are now better able to communicate with consumers and potential consumers. Using the systems and methods of the present invention, he/she need only scan the item barcode, RFID tag, or the like in order to queue up a comprehensive listing of its nutritional information and receive promotional information. In a preferred embodiment, the consumer will have previously entered his own nutritional requirements, goals, or the like, whereby the systems and methods of the present invention may customize the data for the consumer's use.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What is claimed is:

1. A method for facilitating access to manufacturer verified nutritional information and incentives via a mobile device comprising the steps of:
accessing a database of manufacturer verified nutritional information and incentives related to food items which have been tagged under a GS1 system standard on a mobile device;
scanning a global key standard affixed to a food item; and,
retrieving previously uploaded nutritional information and incentives for said food item from a product information database.

2. A method for facilitating access to manufacturer verified nutritional information and incentives via a mobile device as claimed in claim 1 wherein said global key standard is a barcode.

3. A method for facilitating access to manufacturer verified nutritional information and incentives via a mobile device as claimed in claim 1 wherein said global key standard is an RFID tag.

4. A method for facilitating access to manufacturer verified nutritional information and incentives via a mobile device as claimed in claim 1 wherein said incentives are chosen from the group consisting of a human readable code, machine readable code, coupon, discount code, bar code, and quick response code.

5. A method for facilitating access to manufacturer verified nutritional information and incentives via a mobile device as claimed in claim 1 wherein said incentives are cross-promotional incentives or competitive product incentives.

6. A method for facilitating access to manufacturer verified nutritional information and incentives via a mobile device as claimed in claim 1 wherein said product information database is a GS1 system.

7. A method for facilitating access to manufacturer verified nutritional information and incentives via a mobile device as claimed in claim 6 wherein said GS1 system further comprises a barcode standard, an eCom standard, the GDSN (Global Data Synchronization Network) standard, and an EPCglobal standard.

8. A method for facilitating access to manufacturer verified nutritional information and incentives via a mobile device as claimed in claim 1 wherein the step of accessing a network site, downloading and installing a software application, or executing a binary code or other machine readable instruction on a mobile device further comprises the step of inputting consumer nutritional goals, restrictions, and wellness information on said mobile device.

9. A method for facilitating access to manufacturer verified nutritional information and incentives via a mobile device as claimed in claim 1 wherein the step of retrieving previously uploaded nutritional information and incentives for said food item from a product information database further comprises the step of displaying nutritional information customized for a consumer.

10. A method for facilitating access to nutritional information and incentives via a mobile device as claimed in claim 9 wherein the step of displaying nutritional information customized for a consumer further comprises tracking the glycemic indices of the food items being scanned and maintaining a running tally of caloric intake.

11. A method for facilitating access to nutritional information and incentives via a mobile device as claimed in claim 9 wherein the step of displaying nutritional information customized for a consumer further comprises flagging food items which include particular allergens.

12. A method for facilitating access to nutritional information and incentives via a mobile device as claimed in claim 9 wherein the step of displaying nutritional information customized for a consumer further comprises flagging one or more of the following: Kosher, Halal, vegetarian, gluten free, genetically modified organism (GMO) free, trans-fat free, or organic items.

13. A method for facilitating access to nutritional information and incentives via a mobile device comprising the steps of:
inputting manufacturer verified nutritional information and incentives related to specific food items into a dedicated product information database using the GS1 system of standards;
accessing said product information database on a mobile device;
scanning a GS1 system barcode affixed to a food item; and,
retrieving nutritional information and incentives for said scanned food item from said product information database.

14. A method for facilitating access to nutritional information and incentives via a mobile device as claimed in claim 13 wherein said product information database is a GS1 system.

15. A method for facilitating access to nutritional information and incentives via a mobile device as claimed in claim 14 wherein said GS1 system further comprises a barcode standard, an eCom standard, the GDSN (Global Data Synchronization Network) standard, and an EPCglobal standard.

16. A method for facilitating access to nutritional information and incentives via a mobile device comprising the steps of:
inputting manufacturer verified nutritional information and incentives into a product information database;
associating said nutritional information and incentives with a GS1 identified food item;
accessing said product information database on a mobile device;
scanning a product identification tag affixed to a food item; and,
retrieving nutritional information and incentives associated with said product identification tag and its related food item from said product information database.

17. A method for facilitating access to nutritional information and incentives via a mobile device as claimed in claim 16 wherein said incentives are chosen from the group consisting of a human readable code, machine readable code, coupon, discount code, bar code, and quick response code.

18. A method for facilitating access to nutritional information and incentives via a mobile device as claimed in claim 16 wherein said GS1 system comprises a product identification tag with a barcode standard.

19. A method for facilitating access to nutritional information and incentives via a mobile device as claimed in claim 18 wherein the step of retrieving nutritional information and incentives associated with said product identification tag and said food item from said product information database further comprises the step of displaying nutritional information customized for a consumer.

20. A method for facilitating access to nutritional information via a mobile device as claimed in claim 19 wherein the step of displaying nutritional information customized for a consumer comprises one or more of the following information areas: tracking the glycemic indices of the food item being scanned, maintaining a running tally of caloric intake, flagging food items which include particular allergens and flagging Kosher, Halal, vegetarian, gluten free, genetically modified organism (GMO) free, trans-fat free, or organic food items.
